(19) United States
(12) Patent Application Publication
(10) Pub. No.: US 2008/0304716 A1
(43) Pub. Date: Dec. 11, 2008

(54) FACE RECOGNITION DEVICE

(75) Inventor: Jyunji HIROSE, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Aruze Corp., Koto-ku (JP)

(21) Appl. No.: 12/116,462

(22) Filed: May 7, 2008

(30) Foreign Application Priority Data
Jun. 7, 2007 (JP) 2007-151962

(51) Int. Cl. G06K 9/00

(52) U.S. Cl. 382/118

(57) ABSTRACT

A face recognition device of the present invention comprises a plurality of imaging devices capable of simultaneously capturing the face of a person from directions different from one another, and a storage device, the device further comprising: a depression/protrusion data determination device determining data indicating difference of areas of portions in a predetermined color, as depression/protrusion data indicating facial depression/protrusion features of the person, by calculating the difference of the areas based on comparison of images including the face captured from two directions, the images being simultaneously captured using the plurality of imaging devices; and an identification device identifying the person by comparing the depression/protrusion data of the person determined by the depression/protrusion data determination device with individual identification data previously stored in the storage device to be the reference of comparison with the depression/protrusion data.

### CROSS-REFERENCE TO RELATED APPLICATIONS

This application claims benefit of priority based on Japanese Patent Application No. 2007-151962 filed on Jun. 7, 2007. The contents of this application are incorporated herein by reference in their entirety.

### BACKGROUND OF THE INVENTION

1. Field of the Invention

The present invention relates to a face recognition device.

2. Discussion of the Background

Recently, the face recognition technology capable of identifying the face of an individual has been developed, and is on its way to being used in variety of instances including entrance/exit control and suspicious person monitoring.

In a typical face recognition device, data showing a facial image of each individual person is previously registered as data unique to that person (individual identification data). In the identification stage, a newly input image is compared with the registered image, to determine whether or not the person of the input image is any of the persons whose facial image has been previously stored (see JP-A 2006-236244).

As the conventional face recognition device, a face recognition device conducting face recognition based on the two-dimensional features of the face of an individual has prevailed. However, in the recent years, a face recognition device conducting face recognition by recognizing the three-dimensional features of the face of the person has been making an appearance (e.g., see JP-A 2004-295813).

The contents of JP-A 2006-236244 and JP-A 2004-295813 are incorporated herein by reference in their entirety.

### SUMMARY OF THE INVENTION

Although facial feature portions (eyes, nose, mouth and the like) are extracted in recognition in the above-described conventional face recognition device, extraction of these features requires highly complicated processing.

Further, previously registered individual identification data has an extremely large volume of image data and the like.

As described above, the conventional face recognition devices have a problem in that conducting identification takes time since complicated processing is conducted in order to extract the facial features. Further, since a large volume of data is stored as individual identification data, there is also a problem in that a large-capacity memory needs to be provided in the case of storing individual identification data of a large number of people.

From those standpoints, in recent years, appearance of a face recognition device capable of conducting identification in a fast and simple manner has been desired, and the technological development thereof has been promoted.

The present invention was made with attention focused on the above-mentioned problems, and has an object of providing a face recognition device capable of conducting identification in a fast and simple manner.

In order to solve the above-described problems, the present invention provides the following face recognition device.

(1) A face recognition device provided with a plurality of imaging devices capable of simultaneously capturing the face of a person from directions different from one another, and a storage device, the device comprising:

a depression/protrusion data determination device determining data indicating difference of areas of portions in a predetermined color, as depression/protrusion data indicating facial depression/protrusion features of the person, by calculating the difference of the areas based on comparison of images including the face captured from two directions, the images being simultaneously captured using the plurality of imaging devices; and

an identification device identifying the person by comparing the depression/protrusion data of the person determined by the depression/protrusion data determination device with individual identification data previously stored in the storage device to be the reference of comparison with the depression/protrusion data.

According to the invention of (1), a plurality of images indicating the face of a person simultaneously captured from directions different from one another are obtained using the plurality of imaging devices. Then, the difference of areas of the portions in the predetermined color (the shadow portions generated due to the depression/protrusion on the face) is calculated, and the data indicating the difference of areas is determined as the depression/protrusion data indicating the facial depression/protrusion of the person.

Thereafter, the determined depression/protrusion data is compared with the previously registered individual identification data to be the reference of comparison, so as to identify the person.

As described above, in the invention of (1), it is possible to promptly conduct identification without taking time in processing, since the comparatively simple processing of obtaining the difference of the predetermined areas, not the complicated processing of extracting specific facial features such as the eyes, nose, and mouth, is conducted.

Further, in the invention of (1), the data stored as the individual identification data is data showing the difference of areas of the shadow portions in the case where images of the face of the person are simultaneously captured from directions different from one another and does not have a large volume as image data. Therefore, since the volume of data to be stored is small, even individual identification data of a large number of people can be stored in a small volume.

Further, in the invention of (1), data indicating the facial depression/protrusion features is used in identification. Namely, face recognition is conducted based on the three-dimensional features of the face.

The three-dimensional features of the face indicate the irregularities of face parts, and are unique to each person. Namely, since the depression/protrusion on the face represents the facial features of a person extremely well, comparatively highly accurate identification can be realized according to the invention of (1), even though a simple method is used therein.

Further, the present invention provides the following face recognition device.

(2) The face recognition device according to claim 1, further comprising a lighting device for applying light to the face of the person from a predetermined direction,

wherein

the depression/protrusion data determination device determines

data indicating difference of areas of portions in the predetermined color, as depression/protrusion data indicating facial depression/protrusion features of the person, by calculating the difference of the areas based on comparison of images including the face captured from two directions, the images being simultaneously captured using the plurality of imaging devices while the lighting device is applying light to the face of the person.

Furthermore, according to the invention of (2), the imaging devices capture images of the face of the person while the lighting device is applying light to the face of the person, and an image including the face can be obtained. Then, from the image including the face, the depression/protrusion data used in identification can be generated.

In the invention of (2), since the imaging devices capture images of the face of the person while the lighting device is applying light to the face of the person, effects of the lighting condition (entrance of the natural light, the number and positions of the fluorescent lights and the like) of the place where the image is captured can be eliminated. Therefore, it is possible to stably obtain the depression/protrusion data with high accuracy.

Furthermore, while the portion to which light is applied becomes brighter, the portion where light does not reach due to the depression/protrusion on the face becomes darker. Therefore, the brightness difference can be greater and the depression/protrusion data with high accuracy can be obtained.

Further, the present invention provides the following face recognition device.

(3) A face recognition device comprising: a plurality of cameras capable of simultaneously capturing the face of a person from directions different from one another; an arithmetic processing device; and a storage device,

wherein

the arithmetic processing device is to execute the processing of

(A) determining data indicating difference of areas of portions in a predetermined color, as depression/protrusion data indicating facial depression/protrusion features of the person, by calculating the difference of the areas based on comparison of images including the face captured from two directions, the images being simultaneously captured using the plurality of camera, and

(B) identifying the person by comparing the depression/protrusion data of the person determined in the processing (A) with individual identification data previously stored in the storage device to be the reference of comparison with the depression/protrusion data.

According to the invention of (3), a plurality of images indicating the face of the person simultaneously captured from directions different from one another are obtained using the plurality of cameras. Then, the difference of areas of the portions in the predetermined color (the shadow portions generated due to the depression/protrusion on the face) is calculated, and the data indicating the difference of areas is determined as the depression/protrusion data indicating the facial depression/protrusion of the person.

Thereafter, the determined depression/protrusion data is compared with the previously registered individual identification data to be the reference of comparison, so as to identify the person.

As described above, in the invention of (3), it is possible to promptly conduct identification without taking time in processing, since the comparatively simple processing of obtaining the difference of the predetermined areas, not the complicated processing of extracting specific facial features such as the eyes, nose, and mouth, is conducted.

Further, in the invention of (3), the data stored as the individual identification data is data showing the difference of areas of the shadow portions in the case where images of the face of the person are simultaneously captured from directions different from one another and does not have a large volume as image data. Therefore, since the volume of data to be stored is small, even individual identification data of a large number of people can be stored in a small volume.

Further, in the invention of (3), data indicating the facial depression/protrusion features is used in identification. Namely, face recognition is conducted based on the three-dimensional features of the face.

The three-dimensional features of the face indicate the irregularities of face parts, and are unique to each person. Namely, since the depression/protrusion on the face represents the facial features of a person extremely well, comparatively highly accurate identification can be realized according to the invention of (3), even though a simple method is used therein.

Further, the present invention provides the following face recognition device.

(4) The face recognition device according to claim 3, further comprising a lamp for applying light to the face of the person from a predetermined direction,

wherein

the processing (A) is the processing of

determining data indicating difference of areas of portions in the predetermined color, as depression/protrusion data indicating facial depression/protrusion features of the person, by calculating the difference of the areas based on comparison of images including the face captured from two directions, the images being simultaneously captured using the plurality of cameras while the lamp is applying light to the face of the person.

Furthermore, according to the invention of (4), the cameras capture images of the face of the person while the lamp is applying light to the face of the person, and an image including the face can be obtained. Then, from the image including the face, the depression/protrusion data used in identification can be generated.

In the invention of (4), since the cameras capture images of the face of the person while the lamp is applying light to the face of the person, effects of the lighting condition (entrance of the natural light, the number and positions of the fluorescent lights and the like) of the place where the image is captured can be eliminated. Therefore, it is possible to stably obtain the depression/protrusion data with high accuracy.

Furthermore, while the portion to which light is applied becomes brighter, the portion where light does not reach due to the depression/protrusion on the face becomes darker. Therefore, the brightness difference can be greater and the depression/protrusion data with high accuracy can be obtained.

According to the present invention, face recognition can be conducted in a fast and simple manner.

### BRIEF DESCRIPTION OF THE DRAWINGS

FIG. 1 is a block diagram showing an internal configuration of a face recognition device according to one embodiment of the present invention.

FIG. 2A is an overhead schematic view of a front camera, a side camera, and the face of a person.

FIG. 2B is a lateral schematic view of a front camera, an upper camera, and the face of a person.

FIG. 3 is a view for explaining a shadow generated based on a nose.

FIG. 4 is a flowchart showing face recognition processing conducted by a control portion.

### DESCRIPTION OF THE EMBODIMENTS

The present invention is for conducting face recognition by using facial depression/protrusion features.

The depression/protrusion features are different for each person. The depression/protrusion features are not particularly limited, and examples thereof include the height of the nose, the degree of depressions of the eyes, and the protrusion of the lips.

The face recognition device according to the present embodiment is provided with three cameras which capture the face of a person from directions different from one another. It is possible to three-dimensionally recognize the facial features by capturing images of the face of the person from different directions using the plurality of cameras.

Specifically, the facial features are three-dimensionally recognized as described below.

(i) Since a human face has depressed/protruding parts, shadows generate due to the depressed/protruding parts of the face under a situation where the face is lighted.

(ii) When the shadows are observed from directions different from one another, difference generates in the areas of the shadow portions, due to the depressed/protruding parts of the face.

(iii) Conversely, the difference of the areas of the shadow portions calculated from the images obtained by capturing the face of the person from directions different from one another becomes the numeral value indicating the facial depression/protrusion features. Namely, calculation of the difference of the areas (hereinafter, also referred to as “area difference”) enables three-dimensional recognition of the facial features.

Hereinafter, the details of the present embodiment will be described using the drawings.

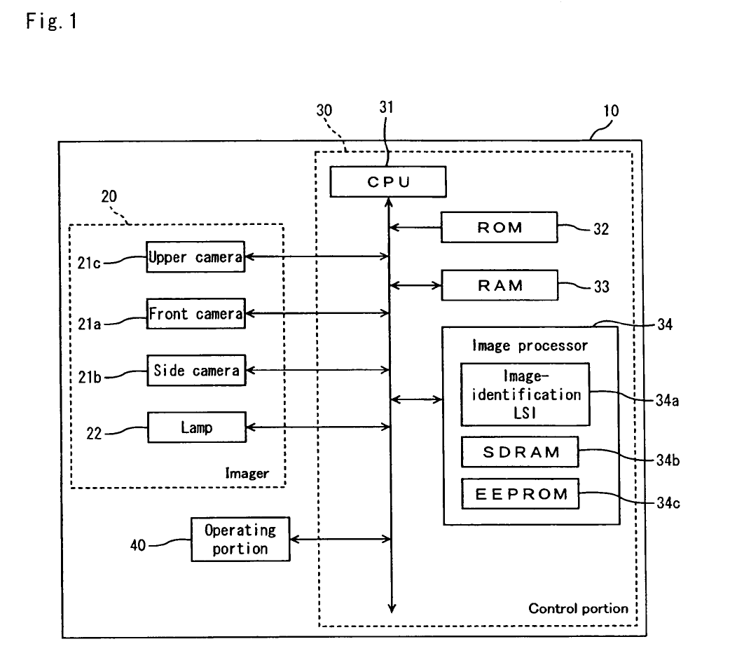

FIG. 1 is a block diagram showing an internal configuration of a face recognition device according to one embodiment of the present invention.

As shown in FIG. 1, a face recognition device 10 comprises an imager 20, a control portion 30, and an operating portion 40.

The imager 20 is provided with a front camera 21a, a side camera 21b, an upper camera 21c, and a lamp 22. The front camera 21a, the side camera 21b, and the upper camera 21c are also referred to as “three cameras” hereinafter.

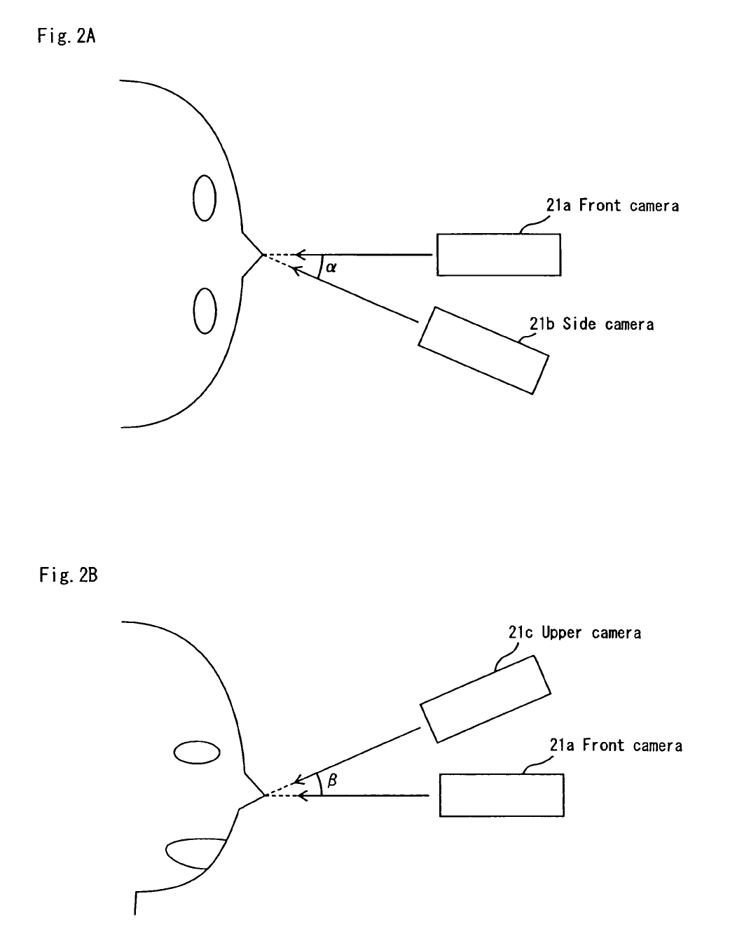

FIG. 2A and FIG. 2B show a positional relationship among three cameras and the face of a person whose images are to be captured.

FIG. 2A is an overhead schematic view of the front camera, the side camera, and the face of the person.

FIG. 2B is a lateral schematic view of the front camera, the upper camera, and the face of the person.

As shown in FIG. 2A and FIG. 2B, the front camera 21a captures the face of the person from the front. As shown in FIG. 2A, the side camera 21b is arranged in a position that is a degrees (α=5°, in the present embodiment) away in the lateral direction from the front camera 21a, with the tip of the nose as the center. Further, as shown in FIG. 2B, the upper camera 21c is arranged in a position that is β degrees (β=5°, in the present embodiment) away in the upper direction from the front camera 21a, with the tip of the nose as the center.

Although α=β=5° in the present embodiment, the values of α and β are not limited to this example. For example, the values of α and β can be any desired value satisfying 0<α<10°, 0°<β<10°. Further, the values of α and β may be the same or different.

Hereinafter, the direction from which the front camera 21a captures images is also referred to as a “front direction”. Further, the direction from which the side camera 21b captures images is also referred to as a “lateral direction”. Furthermore, the direction from which the upper camera 21c captures images is also referred to as an “upper direction”.

The lamp 22 is for applying light to the face of the person when the three cameras capture images.

In the present embodiment, the front camera 21a, the side camera 21b, and the upper camera 21c capture images of the face of the person while the lamp 22 is applying light to the face of the person.

Further, the three cameras capture images at the same time.

The front camera 21a, the side camera 21b, and the upper camera 21c function as the imaging devices in the present invention.

In the present embodiment, the face recognition device 10 is provided with the three cameras, that is, the front camera 21a, the side camera 21b, and the upper camera 21c. In the present invention, the number of imaging devices is not limited to 3, but a desired number can be adopted that is 2 or more. It is to be noted that the number of the imaging devices is desirably three in the present embodiment, from points of view of conducting face recognition with high accuracy and of reducing a processing amount required in identification.

Moreover, in regard to the positions of the imaging devices, it is desirable to adopt an arrangement in which a single imaging device A is positioned in the front of the subject, a single or a plurality of imaging devices is positioned in the upper or lower direction with respect to the imaging device A, and a single or a plurality of imaging devices is positioned in the lateral direction with respect to the imaging device A.

As described above, arranging the imaging devices respectively in the front as well as in the upper, lower, and lateral directions cultivates the correlative relationship of the shadow area difference in the images captured by the respective imaging devices and the facial features of a person being the subject; and with the area difference, identification of the facial features of the person is facilitated.

Further, in the present embodiment, the three cameras are arranged so as to be capable of capturing the face of the person from the respective front direction, the side direction, and the upper direction. However, in the present invention, the directions from which the imaging devices capture images of the face of a person are not particularly limited. For example, two side cameras may be arranged in symmetric positions with respect to the front camera, and the face of the person may be captured from the front, right and left.

In the present invention, the directions from which a plurality of imaging devices capture images are not particularly limited so long as a plurality of imaging devices are arranged so as to be capable of capturing the face of the person from directions different from one another.

Furthermore, the lamp 22 functions as the lighting device in the present invention.

These have been the descriptions of the imager 20.

Next, descriptions of the control portion 30 will be given.

The control portion 30 includes a CPU 31, a ROM 32, and a RAM 33.

The ROM 32 is a nonvolatile memory, to which a program executed by the CPU 31, data used when the CPU 31 conducts processing, and the like are stored. Particularly in the present embodiment, the ROM 32 stores individual identification data. The individual identification data indicates facial image features of each person and is unique to the person. The details of the individual identification data will be described later. The ROM 32 functions as the storage device in the present invention and corresponds to the storage device in the present invention.

The RAM 33 is a volatile memory, to which data corresponding to the processing result and the like conducted by the CPU 31 and the like are temporarily stored.

The CPU 31 is connected to an image processor 34 and the operating portion 40.

The image processor 34 conducts processing of calculating the areas of the portions in a predetermined color, the processing being required for determination of the depression/protrusion data, based on the image data output from the three cameras. The depression/protrusion data indicates the three-dimensional features of the face (depression/protrusion of the face) pf a person and indicates the area difference described above. The details of the depression/protrusion data and the predetermined color will be described later.

The image processor 34 is provided with an image identification LSI 34a, an SDRAM 34b, and an EEPROM 34c. Although not shown in the drawings, the image identification LSI 34a comprises: a module provided with a coprocessor that can process a plurality of data in parallel for a single command; a DRAM; and a DMA controller. The SDRAM 34b temporarily stores the image data output from the three cameras. The EEPROM 34c stores information indicating the predetermined color to be referred to in calculation of the areas of the portions in the predetermined color.

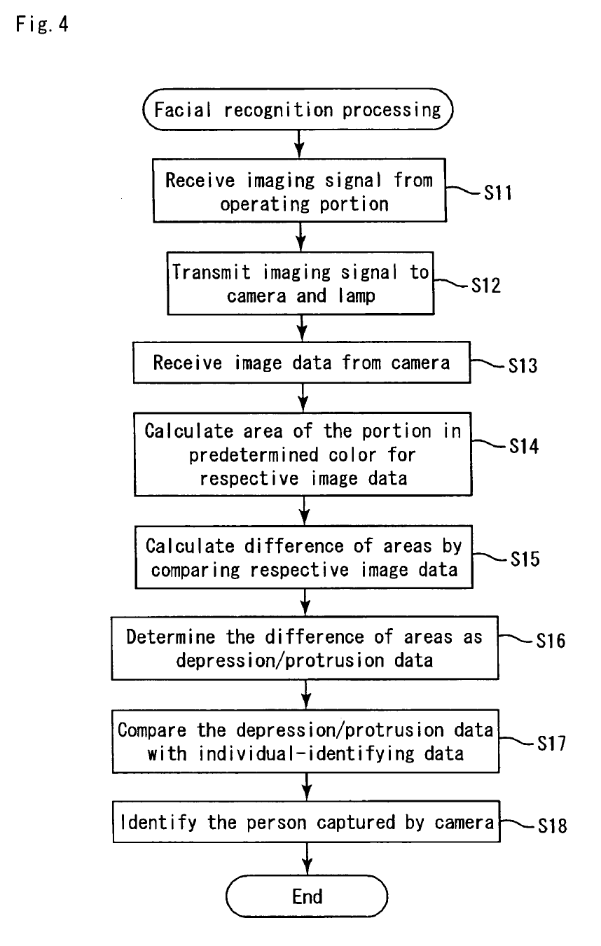

The operating portion 40 is a button for the person to be the subject of face recognition to input to the CPU 31a command to conduct processing relating to face recognition (face recognition processing, see FIG. 4). When the person operates the operating portion 40, an identification-commanding signal is output to the CPU 31. The identification-commanding signal indicates a command to execute of face recognition processing. Upon receipt of the signal, the CPU 31 conducts the facial identification processing. The details of the processing will be described using FIG. 4.

Here, the depression/protrusion data will be described.

The depression/protrusion data indicates the above-described area difference.

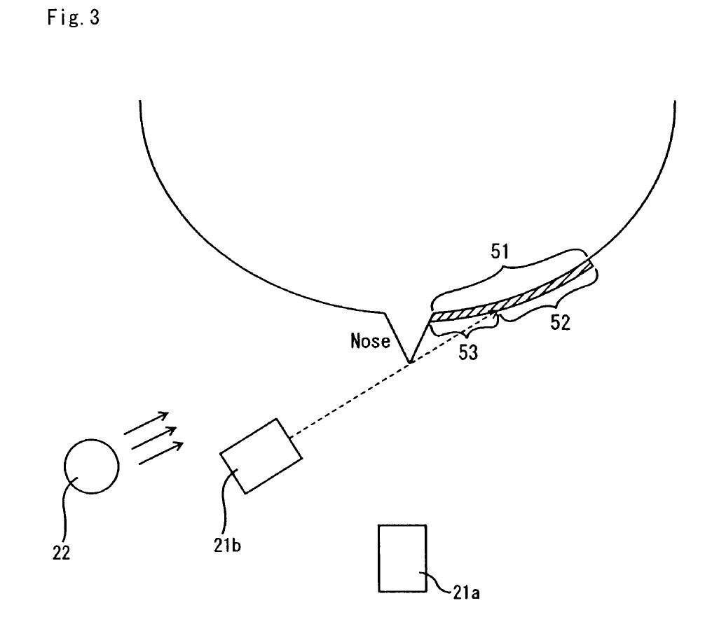

Hereinafter, descriptions will be given for determination method of the depression/protrusion data (calculation method of the area difference), using FIG. 3. It is to be noted that the method of calculating the area difference from the shadow generated based on the “nose” representing the “protrusion” on the face.

FIG. 3 is a view for explaining shadows generated based on a nose.

As shown in FIG. 3, light is applied by the lamp 22 to the face of a person from the right direction of the person in the present embodiment. As a result, a shadow 51 based on the nose is generated on the left side portion of the nose. When the front camera 21a captures the face of the person, the whole shadow 51 is included in the image obtained by capturing images.

On the other hand, since a part of the shadow 51 (the portion of a shadow 53) is located behind the protrusion of the nose when viewed from the side, only a shadow 52 in the shadow 51 is included in the image obtained by the side camera 21b.

In the present embodiment, the area difference is calculated by subtracting the area of the shadow 52 in the image obtained by the side camera 21b, from the area of the shadow 51 in the image obtained by the front camera 21a.

As described above, the calculation method of the area difference has been described by using FIG. 3.

Here, the calculation method of the area difference has been described based on the shadow generated based on the nose. However, the depression/protrusion on the face is not formed only by the nose but by the whole face. Accordingly, the shadow due to the depression/protrusion on the face is not limited to the shadow generated based on the nose but is generated based on the depression/protrusion patterns on the whole face. In the present specification, only the shadow generated based on the nose has been described for the sake of simplifying the descriptions; however, in the present embodiment, area differences are calculated based on the shadows of the whole face including the eyes, the mouth, and the like. It is to be noted that, although the case is described in which the area differences are calculated based on the shadows generated with respect to the whole face in the present embodiment, the area differences may be calculated based on the shadows generated with respect to apart of the face (e.g., nose, eyes, and lips).

Next, processing relating to face recognition (face recognition processing) conducted by the control portion 30 will be described by using FIG. 4.

FIG. 4 is a flowchart showing face recognition processing conducted by a control portion.

The control portion 30 corresponds to the arithmetic processing device in the present invention.

First, the CPU 31 provided in the control portion 30 receives an identification-commanding signal transmitted when the person to be identified operates the operating portion 40 (step S11). As described above, the identification-commanding signal indicates a command to execute the face recognition processing.

Next, the CPU 31 transmits a capture signal to the front camera 21a, the side camera 21b, the upper camera 21c, and the lamp 22 (step S12).

Upon receipt of the capture signal, the lamp 22 first applies light to the face of the person. Then, the front camera 21a, the side camera 21b, and the upper camera 21c capture the face of the person. Thereafter, the lamp 22 ends application of light.

Next, the CPU 31 receives image data obtained by capturing images, from the front camera 21a, the side camera 21b, and the upper camera 21c (step S13).

The CPU 31 then transmits to the image processor 34 a signal indicating a command to calculate the areas of the portions in the predetermined color in each image data received in step S13 (step S14). Upon receipt of the signal, the image processor 34 calculates the areas of the portions in the predetermined color.

Here, the predetermined color is a predetermined region in a color space (RGB, HSV or the like), which corresponds to the shadow portion in the case where the shadow falls over the skin of the person. The CPU 31 extracts pixels belonging to the region in the color space in each image data, so as to conduct the processing of calculating the number of the pixels. Since the method of extracting a specific region in a color space is a well-known technique, descriptions thereof will be omitted here (e.g., see JP-A 2004-246424). It is to be noted that the region in the color space, which is to be extracted in step S14, can be determined by using the following method for example. Namely, images are previously captured by a camera in a situation where a shadow falls on the whole face, and based on the color information indicated by the image data obtained by capturing images, the region in the color space can be determined. Then, data indicating the region in the color space is stored in the EEPROM 34c.

Further, although the number of pixels is calculated by the image processor 34 in step S14 in the present embodiment, the number of pixels is also called an area.

Next, the CPU 31 compares the areas calculated by the image processor 34 in step S14 among the respective image data so as to calculate the area difference (step S15). Specifically, the CPU 31 subtracts the area of the portion in the predetermined color in the image data obtained by the side camera 21b, from the area of the portion in the predetermined color in the image obtained by the front camera 21a, so as to calculate the area difference (this value is to be referred to as “A”). Further, the CPU 31 subtracts the area of the portion in the predetermined color in the image obtained by the upper camera 21c, from the area of the portion in the predetermined color in the image obtained by the front camera 21a, so as to calculate the area difference (this value is to be referred to as “B”).

The CPU 31 then determines the area differences (A and B) calculated in step S15, as the depression/protrusion data (step S16). Namely, the depression/protrusion data comprises information on that the difference between the area of the portion in the predetermined color in the image data obtained by the front camera 21a and the area of the portion in the predetermined color in the image obtained by the side camera 21b is A, and that the difference between the area of the portion in the predetermined color in the image obtained by the front camera 21a and the area of the portion in the predetermined color in the image obtained by the upper camera 21c is B.

When executing the processing of step S14 to step S16, the control portion 30 functions as depression/protrusion determination device in the present invention.

In determination of the depression/protrusion data, calculation of the area of the shadow portion generated due to the depression/protrusion on the face is required; in the present embodiment, the method of calculating the area of the portion in the predetermined color has been adopted as the calculation method of the area. However, in the present invention, the calculation method of the area is not limited to this method. For example, the area of the portion with the predetermined brightness may be calculated. The predetermined brightness in this case can be the brightness of the shadow portion in the case where the shadow falls over the skin of the person. Further, as the method of calculating the area of the portion with the predetermined brightness (density), the method of converting the density such as binarizing processing can be adopted. In the case of adopting this method, the area of the portion with the density corresponding to the shadow on the skin of the person, in the image in which the density has been converted should be calculated. It is to be noted that not only one but a plurality of threshold values may be set in the density conversion.

Further, in the present embodiment, the method has been adopted in which the pixels belonging to the region in the color space corresponding to the shadow portion are extracted; and each of the cameras captures images from directions different from one another. Accordingly, the difference in the number of extracted pixels generates due to not only the depression/protrusion of the face but also the difference of the capture directions. Therefore, in the present invention, the effects from the capture direction difference may be eliminated by conducting affine transformation in the images captured from directions other than the front direction.

Next, the CPU 31 compares the depression/protrusion data determined in step S16 with the individual identification data previously stored in the ROM 32 (step S17). As previously mentioned, the individual identification data indicates the facial image features of each person, and is unique to the person. Also, the individual identification data is to be the reference of comparison with the depression/protrusion data.

Namely, the individual identification data indicates the of the facial depression/protrusion features as the depression/protrusion data does, and is previously determined by the methods similar to those in step S11 to step S16. More specifically, the individual identification data is of the difference between the area of the portion in the predetermined color in the image data obtained by the front camera 21a and the area of the portion in the predetermined color in the image data obtained by the side camera 21b, and of the difference between the area of the portion in the predetermined color in the image data obtained by the front camera 21a and the area of the portion in the predetermined color in the image obtained by the upper camera 21c.

In step S17, specifically, the CPU 31 calculates the error between the depression/protrusion data and the individual identification data.

Next, the CPU 31 conducts processing relating to identification of the person whose image is captured by the camera (step S18). More specifically, the CPU 31 determines whether or not the error calculated in step S17 is less than the predetermined threshold value. Then, when determining that the error is less than the predetermined threshold value, the CPU 31 determines that the person whose image is captured by the camera and the previously registered person are the same person.

When executing the processing of step S17 and step S18, the control portion 30 functions as the identifying device in the present invention.

After executing the processing of step S18, the CPU 31 terminates the face recognition processing.

As described above, according to the face recognition device relating to the present embodiment, three images indicating the face of the person simultaneously captured from directions different from one another by the front camera 21a, the side camera 21b, and the upper camera 21c. Then, the difference of areas of the portion (the shadow portion generated due to the depression/protrusion on the face) in the predetermined color is calculated; and the data indicating the difference of areas is determined as the depression/protrusion data indicating the features of the depressed/protruding parts of the face of the person.

The person is then determined by comparing the determined depression/protrusion data and the individual identification data to be the reference of comparison with the depression/protrusion data.

As described above, in the face recognition device according to the present embodiment, it is possible to promptly conduct identification without taking time in processing, since the comparatively simple processing of obtaining the difference of the predetermined areas, not the complicated processing of extracting specific facial features such as the eyes, nose, and mouth, is conducted.

Further, in the face recognition device according to the present embodiment, the data stored as the individual identification data is data showing the difference of areas of the shadow portions in the case where images of the face of the person are simultaneously captured from directions different from one another and does not have a large volume as image data. Therefore, since the volume of data to be stored is small, even individual identification data of a large number of people can be stored in a small volume.

Further, in the face recognition device according to the present embodiment, data indicating the facial depression/protrusion features is used in identification. Namely, face recognition is conducted based on the three-dimensional features of the face.

The three-dimensional features of the face indicate the irregularities of face parts, and are unique to each person. Namely, since the depression/protrusion on the face represents the facial features of a person extremely well, comparatively highly accurate identification can be realized according to the face recognition device relating to the present embodiment, even though a simple method is used therein.

Further, the depression/protrusion data in the present embodiment comprises information relating to the two types of difference of areas, namely, two types of information including information on the difference between the area of the portion in the predetermined color in the image data obtained by the front camera 21a and the area of the portion in the predetermined color in the image data obtained by the side camera 21b, and information on the difference between the area of the portion in the predetermined color in the image data obtained by the front camera 21a and the area of the portion in the predetermined color in the image data obtained by the upper camera 21c. Therefore, as compared to the case of using one type of difference of the areas, more accurate depression/protrusion data can be obtained.

Furthermore, according to the face recognition device relating to the present embodiment, the cameras capture images of the face of the person while the lamp is applying light to the face of the person, and an image including the face can be obtained. Then, from the image including the face, the depression/protrusion data used in identification can be generated.

In the present embodiment, since the cameras capture images of the face of the person while the lamp is applying light to the face of the person, effects of the lighting condition (entrance of the natural light, the number and positions of the fluorescent lights and the like) of the place where the image is captured can be eliminated. Therefore, it is possible to stably obtain the depression/protrusion data with high accuracy.

Furthermore, while the portion to which light is applied becomes brighter, the portion where light does not reach due to the depression/protrusion on the face becomes darker.

Therefore, the brightness difference can be greater and the depression/protrusion data with high accuracy can be obtained.

As described above, the face recognition device according to the present embodiment is capable of conducting face recognition in a fast and simple manner.

Although the present invention has been described with reference to embodiments thereof, these embodiments merely illustrate specific examples, not restrict the present invention. The specific structures of respective means and the like can be designed and changed as required. Furthermore, there have been merely described the most preferable effects of the present invention, in the embodiments of the present invention. The effects of the present invention are not limited to those described in the embodiments of the present invention.

What is claimed as new and desired to be secured by Letters Patent of the United States is:

1. A face recognition device provided with a plurality of imaging devices capable of simultaneously capturing the face of a person from directions different from one another, and a storage device, the device comprising:
a depression/protrusion data determination device determining data indicating difference of areas of portions in a predetermined color, as depression/protrusion data indicating facial depression/protrusion features of the person, by calculating the difference of the areas based on comparison of images including the face captured from two directions, the images being simultaneously captured using said plurality of imaging devices; and
an identification device identifying the person by comparing said depression/protrusion data of the person determined by said depression/protrusion data determination device with individual identification data previously stored in said storage device to be the reference of comparison with said depression/protrusion data.

2. The face recognition device according to claim 1, further comprising a lighting device for applying light to the face of the person from a predetermined direction,
wherein
said depression/protrusion data determination device determines
data indicating difference of areas of portions in the predetermined color, as depression/protrusion data indicating facial depression/protrusion features of the person, by calculating the difference of the areas based on comparison of images including the face captured from two directions, the images being simultaneously captured using said plurality of imaging devices while said lighting device is applying light to the face of the person.

3. A face recognition device comprising: a plurality of cameras capable of simultaneously capturing the face of a person from directions different from one another; an arithmetic processing device; and a storage device,
wherein
said arithmetic processing device is to execute the processing of
(A) determining data indicating difference of areas of portions in a predetermined color, as depression/protrusion data indicating facial depression/protrusion features of the person, by calculating the difference of the areas based on comparison of images including the face captured from two directions, the images being simultaneously captured using said plurality of camera, and
(B) identifying the person by comparing said depression/protrusion data of the person determined in said processing (A) with individual identification data previously stored in said storage device to be the reference of comparison with said depression/protrusion data.

4. The face recognition device according to claim 3, further comprising a lamp for applying light to the face of the person from a predetermined direction,
wherein
said processing (A) is the processing of
determining data indicating difference of areas of portions in the predetermined color, as depression/protrusion data indicating facial depression/protrusion features of the person, by calculating the difference of the areas based on comparison of images including the face captured from two directions, the images being simultaneously captured using said plurality of cameras while said lamp is applying light to the face of the person.
